(19) United States
(12) Patent Application Publication
(10) Pub. No.: US 2007/0104076 A1
(43) Pub. Date: May 10, 2007

(54) Optical pickup

(75) Inventors: Ryotaro Nakagawa, Osaka (JP); Masanori Takahashi, Osaka (JP); Hideaki Funakoshi, Osaka (JP); Teruaki Sogawa, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/506,906

(22) Filed: Aug. 21, 2006

(30) Foreign Application Priority Data
Aug. 22, 2005 (JP) P2005-239569

(51) Int. Cl. G11B 7/00

(52) U.S. Cl. 369/122

(57) ABSTRACT

An optical pickup that includes: a monolithic laser diode; and a photo-detector including each light receiving portion formed on one substrate and corresponding to each laser beam emitted from the monolithic laser diode, wherein the monolithic laser diode is arranged such that each light emitting point belonging to the monolithic laser diode is positioned on each reference axis, and such that each reference axis is inclined from a direction orthogonal to each laminar face containing the each light emitting point in a direction orthogonal to the active layer by an angle.

### BACKGROUND OF THE INVENTION

1. Field of the Invention

The present invention relates to an optical pickup of an optical disk device.

2. Description of the Related Art

An optical disk device for reproducing/recording an optical disk such as a CD or DVD has an optical pickup installed therein. In the related art, there has been developed an optical pickup, which is adapted for recording/reproducing different kinds of disks.

For example, a DVD recorder uses an optical pickup adapted for recording a DVD and reproducing a CD. FIGS. 7 and 8 show an optical system of an optical pickup for a DVD recorder. FIG. 7 is a side elevation, and FIG. 8 is a top plan view.

A laser beam is emitted from a laser diode 1. The laser diode 1 has a configuration shown in FIG. 9. A sub-mount 5 is fixed on a base 4 protruding from a principal face 3a of a disc-shaped stem 3. A monolithic laser diode (hereinafter called as “monolithic LD”) 6 is arranged on a leading end of the upper portion of the sub-mount 5, and a PIN diode is formed on the sub-mount 5 at the back of the monolithic LD 6. The monolithic LD 6 emits laser beams of different wavelengths including a DVD wavelength (e.g., a band of 650 nm) and a CD wavelength (e.g., a band of 780 nm). The PIN diode 7 is an element for receiving the laser beam emitted backward from the monolithic LD 6 thereby to detect the intensity, so as to perform the APC (Automatic Power Control), i.e., the control to make constant the outputs of the laser beams emitted from the monolithic LD 6. A plurality of terminals 2 extend through the stem 3 and are connected with the monolithic LD 6 and the PIN diode 7 through lead wires 8 so that the drive currents are fed to the individual diodes through the terminals 2. Additionally, the principal face 3a of the stem 3 is equipped with a cap (not shown) for covering the structure which is positioned on the side closer to the base 4 than the stem 3.

FIG. 10 is a view showing the periphery of the monolithic LD 6 and viewed from the side of the laser beam emitting direction (in the direction of arrow L in FIG. 9). The monolithic LD 6 has a structure integrated into one chip so that it can output two kinds of wavelengths including the DVD wavelength (e.g., the band of 650 nm) and for the CD wavelength (e.g., the band of 780 nm). The structure includes a common negative electrode 9, a GaAs substrate 10, an active layer 11, a DVD-side p-electrode 14, and a CD-side p-electrode 15. On the GaAs substrate 10, there are laminated various layers containing the active layer, the lowest layer of which is connected with the DVD-side p-electrode 14 and the CD-side p-electrode 15. A DVD light emitting point 12 and a CD light emitting point 13 are formed in the active layer 11. The DVD-side p-electrode 15 is connected with a DVD-side positive electrode 16 formed on the sub-mount 5, and the CD-side p-electrode 15 is connected with a CD-side positive electrode 17 formed on the sub-mount 5. The common negative electrode 9 is connected with the GaAs substrate 10. When an electric current is fed to the electrodes, the DVD recording laser beam (having the wavelength of 650 nm) is emitted from the DVD light emitting point 12, and the CD reproducing laser beam (having the wavelength of 780 nm) is emitted from the CD light emitting point 13. The DVD recording laser beam has a higher output than that of the CD reproducing laser beam (e.g., the DVD recording laser beam has an output of 135 mW whereas the CD reproducing laser beam has an output of 8 mW). The DVD light emitting point 12 and the CD light emitting point 13 are highly precisely positioned, because the positions are determined by a semiconductor wafer process.

The DVD recording laser beam or the CD reproducing laser beam, emitted from the laser diode 1 thus configured, is divided through a grating 18 into one main beam and two sub-beams. Moreover, the laser beam having passed through a PBS (Polarized Beam Splitter) 19 and a quarter-wavelength plate 20 is reflected by a launching mirror 21 into a collimator lens 22. The laser beam having entered the collimator lens 22 is introduced as a parallel beam into an aperture 23. This aperture 23 has such a wavelength selectivity that it passes the DVD recording laser beam (of the wavelength of 650 nm) as it is but restricts the CD recording laser beam (of the wavelength of 780 nm). The laser beam having passed through the aperture 23 is condensed by an objective lens 24 onto the recording face of a disk 25.

The laser beam reflected by the disk 25 is passed through the objective lens 24, the aperture 23 and the collimator lens 22, and is reflected by the launching mirror 21 through the quarter-wavelength plate 20 into the PBS 19. The laser beam to enter the PBS 19 has passed twice through the quarter-wavelength plate 20 so that it is reflected by the PBS 19 into a cylindrical lens 26.

The cylindrical lens 26 has a curved concave surface, as shown in FIG. 11A and is arranged such that the concave surface faces the PBS 19. FIG. 11B views the cylindrical lens 26 in the direction of arrow A is FIG. 8. As thus viewed, the cylindrical lens 26 is arranged at such an inclination that a center line S is inclined from a vertical direction by 45 degrees in the plane of the drawing.

The laser beam thus having passed through the cylindrical lens 26 is received by a photo-detector 27. FIG. 12 views the photo-detector 27 in the direction of arrow B in FIG. 8. The photo-detector 27 has a structure, in which light receiving portions for the laser beams of the two wavelengths are formed on one silicon substrate 28. Alight receiving portion 30 having quartered light receiving faces receives the main beam of the DVD recording laser beam. The light receiving portions 29 and 31 having halved light receiving faces receive the sub-beams of the DVD recording laser beam. A light receiving portion 33 having quartered light receiving faces receives the main beam of the CD reproducing laser beam. Light receiving portions 32 and 34 having no divided light receiving face receive the sub-beam of the CD reproducing laser beam. The laser beams received by those individual light receiving portions are converted into electric signals, which are used to generate RF signals recorded in the disk, focus error signals and tracking error signals.

Here, the optical pickup thus configured has the following problems.

FIG. 13 is a diagram showing the behaviors of a laser beam emission from the aforementioned monolithic LD 6. The laser beam emitted from the DVD light emitting point 12 or the CD light emitting point 13 has an intensity distribution of an elliptical pattern extended orthogonally to the active layer 11 as to reflect the shape of the light emitting point of the active layer 11. The distribution of the intensity of light of the laser beam has a Gaussian distribution in directions both parallel and orthogonal to the active layer 11. The angle of the portion, at which the intensity of light takes a predetermined ratio (e.g., a half value) or more to the peak value, will be called the “irradiation angle”. The irradiation angle (θ// in FIG. 13) parallel to the active layer 11 will be called the “parallel irradiation angle”, and the irradiation angle (θ^{⊥} in FIG. 13) orthogonal to the active layer 11 will be called the “orthogonal irradiation angle”. FIG. 14 shows the distributions of the intensities of lights of the CD reproducing laser beam and the DVD recording laser beam of a higher output than that of the CD reproducing laser beam, which are orthogonal to the active layer 11. The DVD recording laser beam of the higher output has a small orthogonal emission angle and a steep distribution, whereas the CD reproducing laser beam of the lower output has a large orthogonal emission angle and a gentle distribution.

FIG. 15 is a schematic side elevation of the monolithic LD 6. As shown in FIG. 15, the emission direction of a laser beam emitted from at least one of the emission points of the monolithic LD 6, which has a light intensity peak value, may be deviated orthogonally relative to the active layer 11 of the monolithic LD 6 from a reference axis on the optical path from each light emitting point of the monolithic LD 6 to either the center of the light receiving portion 30 (for the DVD main beam) or the light receiving portion 33 (for the CD main beam) of the photo-detector 27. This angle of deviation will be called the “emission angle” (i.e., Δ θ^{⊥} in FIG. 15). This deviation is caused by the manufacturing errors of the light emitting point of the monolithic LD 6 and the mounting errors of the monolithic LD 6 itself.

The upper face diagram of the distribution of the intensity of light just after emitted from the objective lens 24 of the case, in which the deviation angle deviates orthogonally relative to the active layer from the reference axis, as shown in FIG. 15, is presented in FIG. 16A. The sectional side elevations of the distribution of the intensity of light just after emitted from the objective lens 24 of the cases, in which the emission direction does not deviate from the reference axis and deviates as shown in FIG. 15, are presented in FIG. 16B. Here, letters Dob in FIG. 16 designate the diameter of the laser beam just after emitted from the objective lens 24. When the emission direction of the laser beam thus deviates orthogonally to the active layer from the reference axis, the intensity of light just after emitted from the objective lens 24 stopped down by the aperture 23 or the fixing member of the objective lens 24 deviates in the intensity of light and in the center of gravity.

In response to this deviation of the distribution of the intensity of light just after emitted from the objective lens 24, the distribution of the intensity of light in the light receiving portion of the photo-detector 27 also deviates. The distribution of the intensity of light and the center-of-gravity position (i.e., a mark X) in the light receiving portion 30 (for the DVD main beam) and the light receiving portion (for the CD main beam) of the case, in which the emission direction deviates orthogonally to the active layer from the reference axis, as shown in FIG. 15, are shown in FIG. 17A. When the emission direction of the laser beam thus deviates orthogonally to the active layer from the reference axis, the distribution of the intensity of light in the light receiving portion deviates in a Y-axis direction, and the center-of-gravity of the intensity of light also deviates in the Y-axis direction from the center of the light receiving portion.

If the four light receiving faces of the light receiving portion 30 are designated by a, b, c and d and if the four light receiving faces of the light receiving portion 33 are designated by A, B, C and D, as shown in FIG. 17A, the photo-detector 27 has to be so adjusted that the light receiving balances expressed by the following Formulas (1) and (2) may be ideally 0:
PDY₁=((Iₐ+I_{b})−(I_{c}+I_{d}))/(Iₐ+I_{b}+I_{c}+I_{d})×100 (1)
PDY₂=((I_{A}+I_{B})−(I_{C}+I_{D}))/(I_{A}+I_{B}+I_{C}+I_{D})×100 (2)

Here: PDY₁ [%]: Light receiving balance of the DVD light receiving portion; PDY₂ [%]: Light receiving balance of the CD light receiving portion; and Ii: Intensity of light on the light receiving face i.

The case, as shown in FIG. 17A, in which the adjustment is so made by moving the photo-detector 27 in the Y-axis direction that the center-of-gravity of the intensity of light in the light receiving portion 30 or the DVD light receiving portion may be positioned at the center of the light receiving portion 30, is shown in FIG. 7B. As a result, the light receiving balance (of Formula (1)) in the light receiving portion 30 or the DVD light receiving portion is 0. In the light receiving portion 33 or the CD light receiving portion, however, the center-of-gravity deviation of the intensity of light from the center of the light receiving portion 33 resides so that the light receiving balance (of Formula (2)) does not correspondingly become 0 but resides. This residual is called the “light receiving balance residual”. Due to the manufacturing errors of the light emitting point of the monolithic LD or the mounting errors of the monolithic LD itself, the emission angle of the laser beam disperses between the optical pickups. Depending the magnitude of the emission angle, the center-of-gravity deviation of the intensity of light in the state of FIG. 17A may be so large as to cause the aforementioned light receiving balance residual after the movement adjustment of the photo-detector 27 to exceed an allowable range. If the light receiving balance residual exceeds the allowable range, an adjustment is required because the reading of the disk or the servo action is adversely affected. However, the light receiving balance residual cannot be eliminated by the rotation adjustment of the photo-detector 27. Therefore, the optical system other than the photo-detector 27 has to be so adjusted that the light receiving balance residual may be within the allowable range, but this adjustment becomes a cause for raising the cost.

JP-A-2003-22543 discloses that the deviation of the light receiving balance due to the deviation of the emission direction of the laser beam from the LD from the reference axis parallel to the active layer is adjusted by inclining the LD thereby to adjust the light receiving balance. However, this adjustment has to be made for every optical pickups, thereby to raise the cost.

### SUMMARY OF THE INVENTION

In view of the problems thus far described, the present invention has been conceived to provide an optical pickup capable of suppressing the rise in the cost.

In order to achieve the aforementioned object, according to the invention, there is provided an optical pickup comprising: a monolithic laser diode; and a photo-detector having each light receiving portion formed on one substrate and corresponding to each laser beam emitted from the monolithic laser diode,

wherein the monolithic laser diode is arranged such that each light emitting point belonging to the monolithic laser diode is positioned on each reference axis, and such that each reference axis is inclined from the direction orthogonal to each laminar face containing the each light emitting point and in the direction orthogonal to the active layer by an angle of an average value of the angular deviation of the emission direction orthogonal to the active layer at the light emitting point belonging to the monolithic laser diode.

For example, the invention may be embodied by an optical pickup comprising: a laser diode including a stem, a base protruded from the principal face of the stem, a sub-mount arranged on the base, and a monolithic laser diode arranged over the sub-mount; and a photo-detector having each light receiving portion formed on one substrate and corresponding to each laser beam emitted from the monolithic laser diode, wherein the mounting face of the base for mounting the sub-mount is formed by such an angle with respect to an axis orthogonal to the principal face of the stem as corresponds to an average value of the angular deviation of the emission direction orthogonal to an active layer at a light emitting point belonging to the monolithic laser diode; and the laser diode is arranged such that each light emitting point belonging to the monolithic laser diode is positioned on each reference axis, and such that each reference axis and the axis orthogonal to the principal face of the step are substantially parallel to each other.

For example, the invention may also be embodied by an optical pickup comprising: a laser diode including a stem, a base protruded from the principal face of the stem, a sub-mount arranged on the base, and a monolithic laser diode arranged over the sub-mount; an LD holder having a hole for inserting the laser diode; and a photo-detector having each light receiving portion formed on one substrate and corresponding to each laser beam emitted from the monolithic laser diode, wherein the hole belonging to the LD holder is formed such that the axis extending through the center of the hole is inclined from the axis parallel to the upper face and the lower face of the LD holder by such an angle as corresponds to an average value of the angular deviation of the emission direction orthogonal to an active layer at a light emitting point belonging to the monolithic laser diode; and the LD holder having the laser diode inserted thereinto is arranged such that each light emitting point belonging to the monolithic laser diode is positioned on each reference axis, and such that each reference axis and the axis parallel to the upper face and the lower face of the LD holder are substantially parallel to each other.

For example, the invention may also be embodied by an optical pickup comprising: a laser diode including a stem, abase protruded from the principal face of the stem, a sub-mount arranged on the base, and a monolithic laser diode arranged over the sub-mount; an LD holder having a hole for inserting the laser diode and protrusions formed on the upper face and the lower face; an LD spring having a base portion and leaf portions formed by folding the two ends of the base portion; and a photo-detector having each light receiving portion formed on one substrate and corresponding to each laser beam emitted from the monolithic laser diode, wherein the hole belonging to the LD holder is formed such that the axis extending through the center of the hole is substantially parallel to the upper face and the lower face of the LD holder; the leaf portions have holes for fitting the protrusions therein, and in that the LD spring is arranged such that the leaf portions are substantially parallel to each reference axis; and the LD holder having the laser diode inserted thereinto is fixed on the LD spring by fitting the protrusions in the holes belonging to the leaf portions, such that each light emitting point belonging to the monolithic laser diode is positioned on each reference axis, and such that each reference axis is inclined from the direction orthogonal to each laminar face containing the each light emitting point and in the direction orthogonal to the active layer by an angle of an average value of the angular deviation of the emission direction orthogonal to the active layer at the light emitting point belonging to the monolithic laser diode.

For example, the invention may also be embodied by an optical pickup comprising: a laser diode including a stem, a base protruded from the principal face of the stem, a sub-mount arranged on the base, and a monolithic laser diode arranged over the sub-mount; an LD holder having a hole for inserting the laser diode and protrusions formed on the upper face and the lower face; an LD spring having a base portion and first and leaf portions formed by folding the end portions of the base portion substantially perpendicularly; a base portion for retaining the LD spring; and a photo-detector having each light receiving portion formed on one substrate and corresponding to each laser beam emitted from the monolithic laser diode, wherein the hole belonging to the LD holder is formed such that the axis extending through the center of the hole is substantially parallel to the upper face and the lower face of the LD holder; the first and second leaf portions have holes for fitting the protrusions therein, and in that the LD holder having the laser diode inserted thereinto is fixed by the LD spring such that the first leaf portion and the upper face of the LD holder, and the second leaf portion and the lower face of the LD holder are substantially parallel to each other; the base portion has a stiffening face, against which the base portion is brought into abutment, and in that the stiffening face is inclined from the axis orthogonal to each reference axis by an angle corresponding to an average value of the angular deviation of the emission direction orthogonal to the active layer at the light emitting point belonging to the monolithic laser diode; and the base portion is brought into abutment against the stiffening face such that each light emitting point belonging to the monolithic laser diode may be positioned on each reference axis, and in that the LD spring, on which the LD holder having the laser diode inserted thereinto is fixed, is retained by the base portion.

According to the optical pickup thus constituted, the average light receiving balance residual between the optical pickups can be suppressed to a small value, and the optical pickups, of which the light receiving balance residual exceeds the allowable range, can be suppressed in number, to make unnecessary an adjustment after the movement adjustment of the photo-detector thereby to suppress the rise in the cost.

The optical pickup of the invention can suppress the rise in the cost.

### BRIEF DESCRIPTION OF THE DRAWINGS

FIGS. 1A and 1B are a top plan view and a side elevation of an optical pickup according to an embodiment the invention;

FIG. 2 is an exploded perspective view of a laser diode mounting portion of the optical pickup;

FIG. 3 is a sectional side elevation of a laser diode according to a first embodiment of the invention;

FIG. 4 is a sectional side elevation of a laser diode and an LD holder according to a second embodiment of the invention;

FIG. 5 is a sectional side elevation of a laser diode, an LD holder and an LD spring according to a third embodiment of the invention;

FIG. 6 is a sectional side elevation of a laser diode, an LD holder, an LD spring and a wall portion of a base portion according to a fourth embodiment of the invention;

FIG. 7 is a side elevation of an optical system in an optical pickup;

FIG. 8 is a top plan view of the optical system;

FIG. 9 is a perspective view of a laser diode;

FIG. 10 is a view of the periphery of a monolithic LD and taken from the side of the laser beam emitting direction;

FIGS. 11A and 11B are views showing a cylindrical lens;

FIG. 12 is a diagram showing a photo-detector;

FIG. 13 is a diagram showing the behaviors of a laser beam emission from the monolithic LD;

FIG. 14 is a diagram showing the distributions of the intensities of lights emitted from the monolithic LD, which are orthogonal to an active layer;

FIG. 15 is a diagram showing the deviation of a laser beam in the emission direction orthogonal to the active layer from a reference axis, which is emitted from the monolithic LD;

FIGS. 16A and 16B are diagrams showing the center-of-gravity deviation of such a laser beam just after emitted from an objective lens and accompanying the deviation of the emission direction orthogonal to the active layer from the reference axis as is emitted from the monolithic LD; and

FIGS. 17A and 17B are diagrams showing the light receiving balance adjustments by adjusting the movements of the photo-detector.

### DETAILED DESCRIPTION OF THE PREFFERED EMBODIMENTS

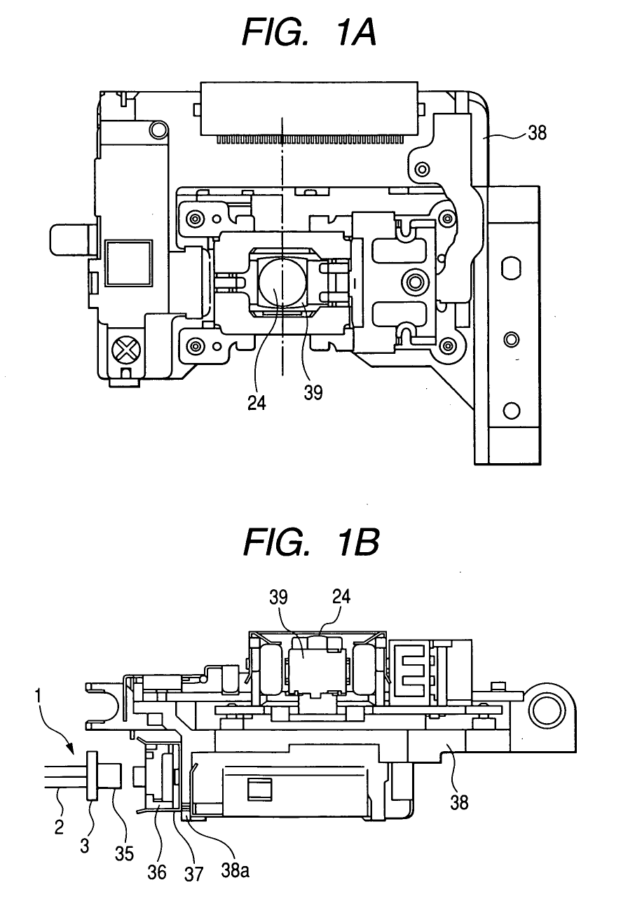

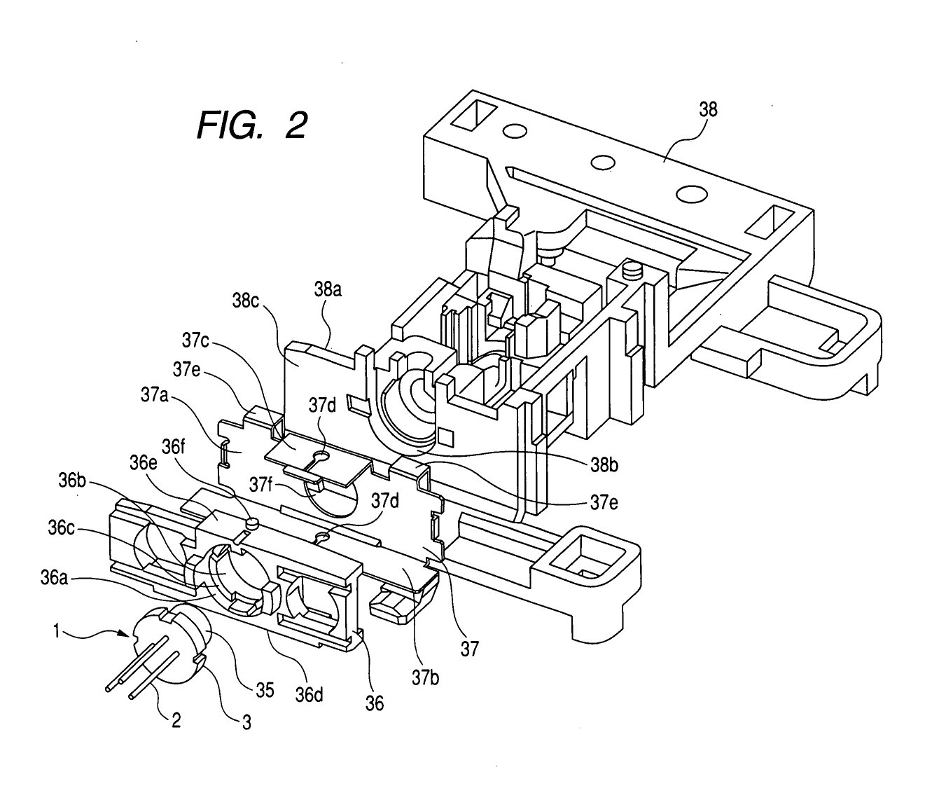

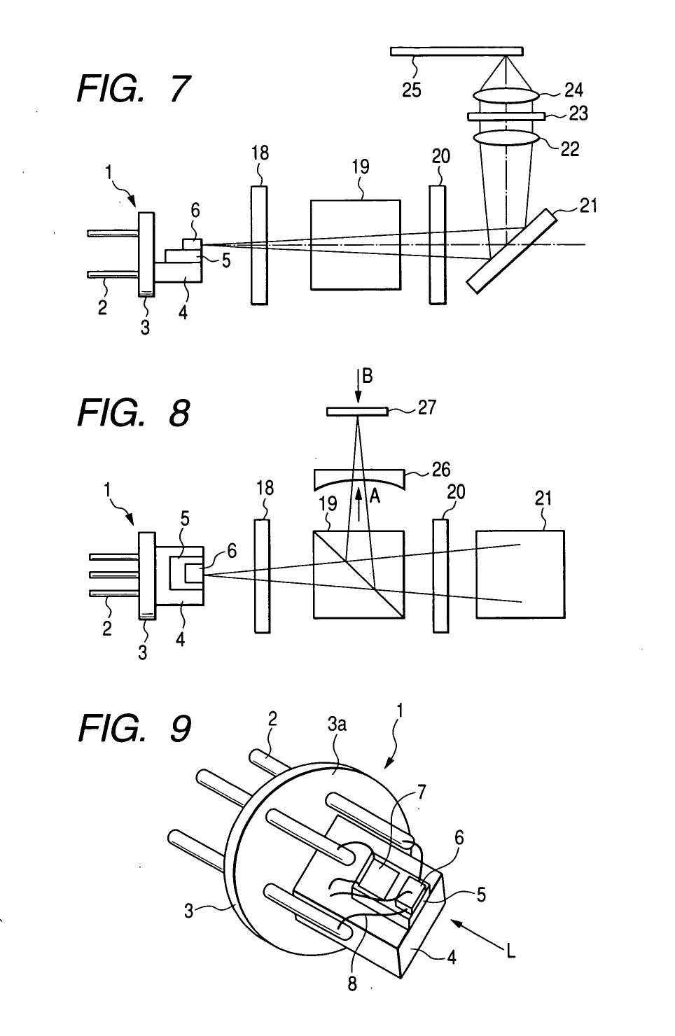

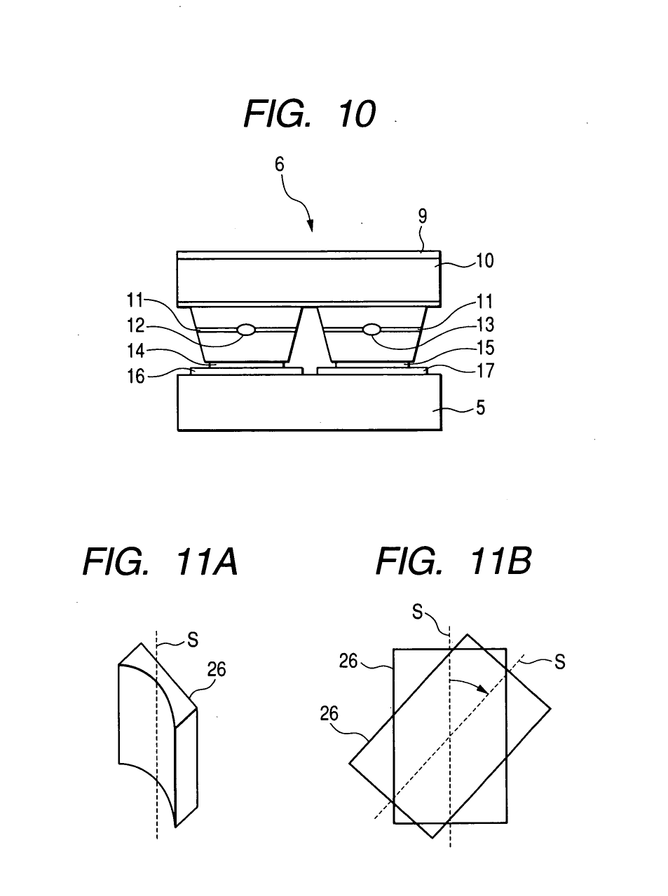

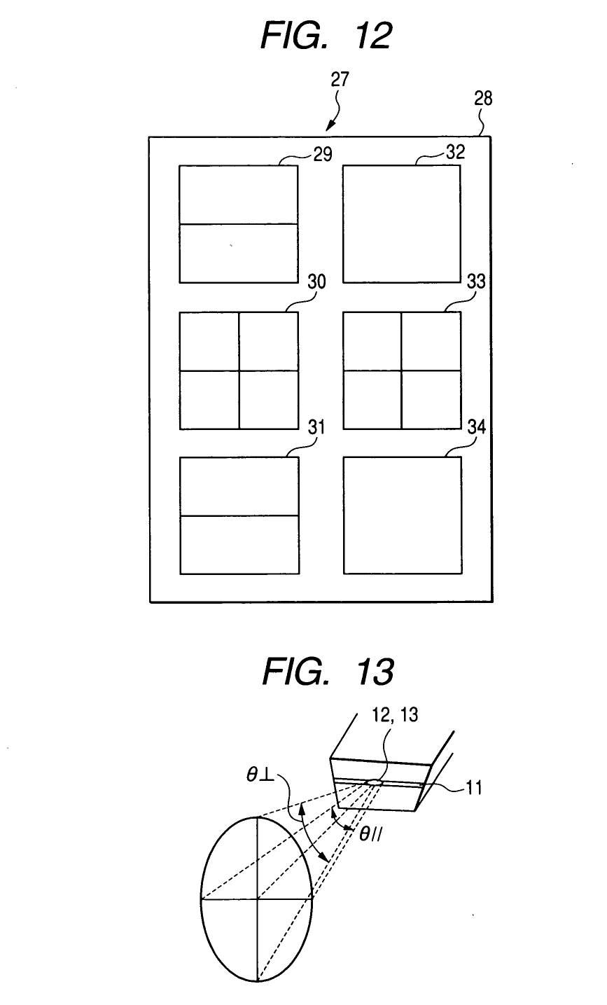

Embodiments of the invention are described with reference to the accompanying drawings. An optical pickup for a DVD recorder is taken as an example. FIG. 1A is a top plan view of an optical pickup according to an embodiment of the invention, and FIG. 1B is a side elevation of the optical pickup (a laser diode 1 is detached in FIG. 1B from the optical pickup). FIG. 2 is an exploded perspective view, viewed from above a portion of the laser diode 1 to be mounted on a base portion 38, of the optical pickup. Here, the configuration of the optical system of the optical pickup is similar to the aforementioned one shown in FIG. 7 and FIG. B.

The laser diode 1 has the aforementioned configuration, as shown in FIG. 9, in which a cap 35 is so mounted on the principal face 3a of the stem 3 as to cover the structure of a monolithic LD 6, a sub-mount 5 and so on, positioned closer to a base 4 than a stem 3. The cap 35 is provided, in the front face of the cap 35, with a hole for passing the laser beam.

An LD holder 36 is provided with holes 36a and 36b, which extend longitudinally therethrough such that the hole 36a has a larger diameter than that of the hole 36b. The laser diode 1 is mounted on the LD holder 36 by press-fitting the stem 3 into the hole 36a so that the principal face 3a of the stem 3 may come into abutment against an abutment face 36c positioned at the boundary between the hole 36a and the hole 36b. At this time, the cap 35 is covered with the hole 36b. Moreover, protrusions 36f are formed at the substantially transverse center portions on the upper face 36d and the lower face 36e of the LD holder 36.

An LD spring 37 is a leaf spring formed of a metal sheet. The LD spring 37 includes a base portion 37a and leaf portions 37b and 37c formed by folding it at the upper and lower ends of the base portion 37a substantially perpendicularly to the base portion 37a into a generally C-shape in a side view. Moreover, the LD spring 37 is folded into a generally L-shape in a side view oppositely of the leaf portion 37c from the lower end of the base portion 37a thereby to form retaining portions 37e transversely across the leaf portion 37c. A hole 37f is formed in the substantially central portion of the base portion 37a. In the substantially transverse center portions of the leaf portions 37b and 37c, there are formed holes 37d, in which the protrusions 36f of the LD holder 36 are fitted to hold the LD spring 37 on the LD holder 36.

The base portion 38 is provided therein with a grating 18, a PES 19, a quarter-wavelength plate 20, a launching mirror 21, a collimator lens 22 and a cylindrical lens 26 (see FIG. 8), and a photo-detector 27 (see FIG. 8) is mounted on the side face. Over the base portion 38, moreover, there is positioned a lens holder 39, which is provided with an aperture 23 (see FIG. 7) and an objective lens 24. The base portion 38 is provided at its one end with a wall portion 38a, which is equipped with a generally U-shaped opening 38b at its transversely central portion. The LD spring 37 is fixed on the base portion 38 by hooking the retaining portions 37e of the LD spring 37 on the transversely two side lower portions of the wall portion 38a across the opening 38b while bringing the base portion 37a of the LD spring 37 on an stiffening face 38c of the wall portion 38a.

As described above, the laser diode 1 is integrated with the base portion 38. The laser beam, as emitted from the laser diode 1, passes through the hole of the cap 35, the holes 36a, 36b and 37f and the opening 38b and through the optical system in the base portion 38 so that it is emitted from the objective lens 24. The laser beam is reflected by the disk 25 to enter the objective lens 24 again, and passes through the optical system in the base portion 38 so that it is received by the photo-detector 27 mounted on the side face of the base portion 38.

Next, embodiments of the individual structures for achieving the object of the invention are described on the optical pickup having the structure thus made.

### First Embodiment

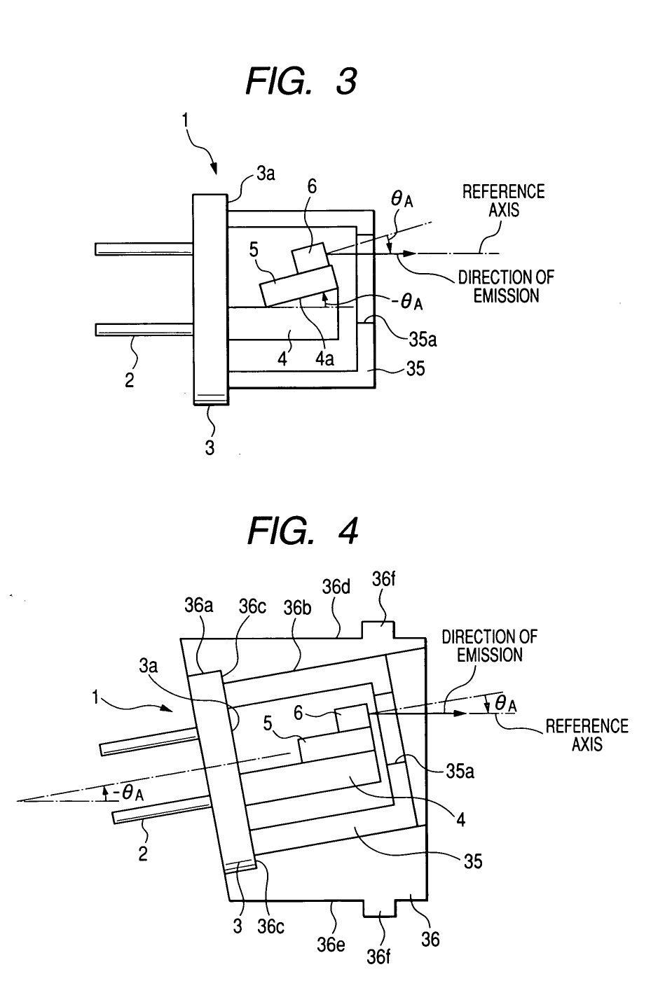

FIG. 3 is a sectional side elevation of the laser diode 1 according to a first embodiment. By the aforementioned structure, the laser diode 1 is integrated with the base portion 38 by the LD holder 36 and the LD spring 37, although not shown.

Here, the monolithic LD 6 has the emission direction precisions on the individual light emitting points as its specifications. The emission direction precisions orthogonal to the active layer are expressed with the average value and the dispersion of the angular deviation orthogonal to the active layer of the emission direction in the direction orthogonal to the laminar face containing the light emitting points. Here, the average value of the angular deviation of the emission direction at a light emitting point 12 for the DVD orthogonal to the active layer is designated by θ_{A}.

The sub-mount 5 is mounted on the upper leading end of the base 4 protruded from the stem 3, and the monolithic LD 6 is mounted on the upper leading end of the sub-mount 5. The cap 35 is mounted on the principal face 3a of the stem 3 and provided in its front face with a hole 35a for passing the laser beam therethrough. A mounting face 4a for mounting the sub-mount 5 is inclined by −θ_{A} with respect to the axis orthogonal to the principal face 3a of the stem 3. As shown in FIG. 3, moreover, the laser diode 1 is so arranged and integrated with the base portion 38 that the individual light emitting points of the monolithic LD 6 are positioned on the individual reference axes, and that the individual reference axes are substantially parallel to the axis orthogonal to the principal face 3a of the stem 3.

As a result, the monolithic LD 6 is arranged to deviate the individual reference axes by θ_{A} orthogonally to the active layer from the direction orthogonal to the individual laminar faces containing the individual light emitting points, so that the average emission direction of the DVD light emitting point 12 is aligned with the reference axis. In case, therefore, the laser beam emitted from the DVD light emitting point 12 is received by a light receiving portion 30 (for the DVD main beam) of the photo-detector 27, the center of gravity of the intensity of light is aligned on the average with the center of the light receiving portion 30 so that the light receiving balance becomes substantially 0 on the average. If the average value of the angular deviation of the emission direction of a CD light emitting point 13 is then equal to the same value θ_{A} as that of the DVD light emitting point 12, the average emission direction of the CD light emitting point 13 is also aligned with the reference axis, and the light receiving balance in a light receiving portion 33 (for the CD main beam) of the photo-detector 27 also becomes substantially 0 on the average, so that the average light receiving balance residual becomes substantially 0.

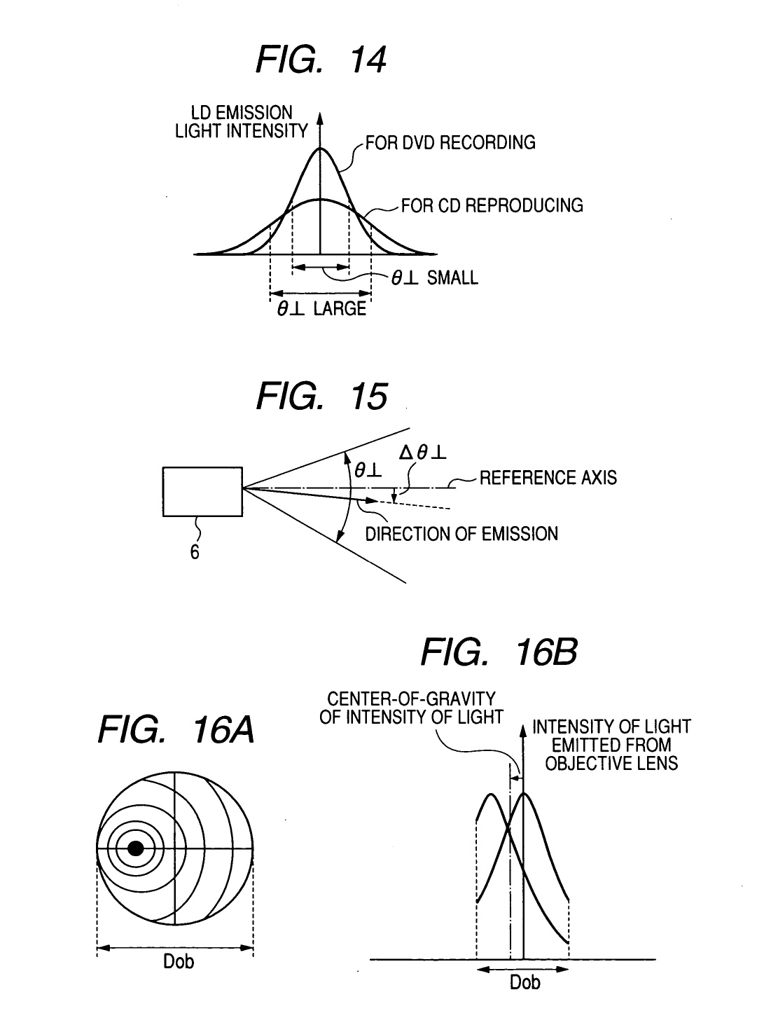

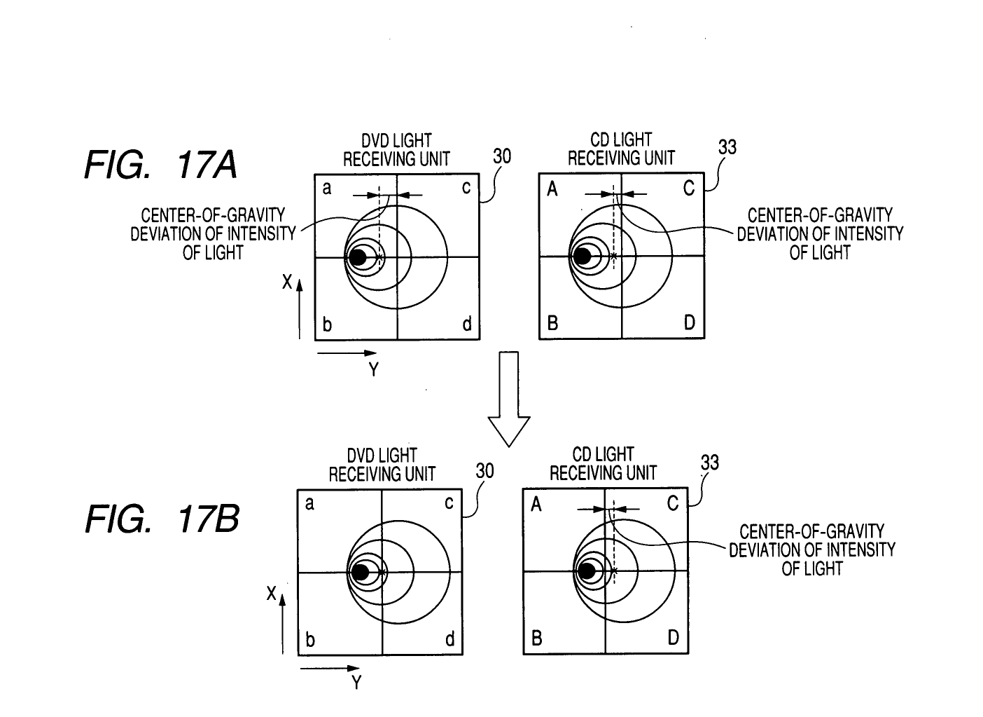

In case the average value of the angular deviation of the emission direction of the CD light emitting point 13 is different from that of the DVD light emitting point 12, the average emission direction of the CD light emitting point 13 deviates from the reference axis. As has been described with reference to FIG. 14, however, the CD reproducing laser beam of a lower output than that of the DVD recording laser beam has a large orthogonal irradiation angle so that the distribution of the intensity of light orthogonal to the active layer becomes gentle. Even if the average emission direction deviates from the reference axis, therefore, the center-of-gravity deviation of the intensity of light of the light receiving portion 33 (for the CD main beam) of the photo-detector 27 from the center of the light receiving portion as well as the light receiving balance deviation is small. As a result, the average light receiving balance residual is so small as to raise no problem.

According to this first embodiment, the average light receiving balance residual between the optical pickups can be suppressed to a small value, and the optical pickups, of which the light receiving balance residual exceeds the allowable range, can be suppressed in number, to make unnecessary an adjustment after the movement adjustment of the photo-detector thereby to suppress the rise in the cost.

### Second Embodiment

FIG. 4 is a sectional side elevation of a laser diode 1 and an LD holder 36 according to a second embodiment. By the aforementioned structure, the laser diode 1 and the LD holder 36 are integrated with the base portion 38 by the LD spring 37, although not shown.

In the laser diode 1, the base 4 is protruded substantially orthogonally to the principal face 3a of the stem 3. The sub-mount 5 is mounted on the upper leading end of the base 4, and the monolithic LD 6 is mounted on the upper leading end of the sub-mount 5. The cap 35 is mounted on the principal face 3a of the stem 3 and provided in its front face with the hole 35a for passing the laser beam therethrough.

As in the foregoing first embodiment, the average value of the angular deviation of the emission direction at the light emitting point 12 of the monolithic LD 6 orthogonal to the active layer is designated by θ_{A}. At this time, the hole 36a and the hole 36b are so formed that the axis extending through the centers of the hole 36a and the hole 36b of the LD holder 36 may be inclined by −θ_{A} from the axis parallel to the upper face 36d and the lower face 36e of the LD holder 36. Moreover, the stem 3 is so press-fitted in the hole 36a as to bring the principal face 3a of the stem 3 into abutment against the abutment face 36c. As shown in FIG. 4, moreover, the ID holder 36 having the laser diode 1 press-fitted therein is so arranged and integrated with the base portion 38 that the individual light emitting points of the monolithic LD 6 are positioned on the individual reference axes, and that the individual reference axes are substantially parallel to the axis parallel to the upper face 36d and the lower face 36e of the LD holder 36.

As a result, the monolithic LD 6 is arranged to deviate the individual reference axes by θ_{A} orthogonally to the active layer from the direction orthogonal to the individual laminar faces containing the individual light emitting points, so that the average emission direction of the DVD light emitting point 12 is aligned with the reference axis. In case, therefore, the laser beam emitted from the DVD light emitting point 12 is received by the light receiving portion 30 (for the DVD main beam) of the photo-detector 27, the center of gravity of the intensity of light is aligned on the average with the center of the light receiving portion 30 so that the light receiving balance becomes substantially 0 on the average. If the average value of the angular deviation of the emission direction of the CD light emitting point 13 is then equal to the same value θ_{A} as that of the DVD light emitting point 12, the average emission direction of the CD light emitting point 13 is also aligned with the reference axis, and the light receiving balance in the light receiving portion 33 (for the CD main beam) of the photo-detector 27 also becomes substantially 0 on the average, so that the average light receiving balance residual becomes substantially 0. Even in case the average value of the angular deviation of the emission direction of the CD light emitting point 13 is different from that of the DVD light emitting point 12, the average light receiving balance deviation is suppressed to a small value for the aforementioned reasons.

According to this second embodiment, the average light receiving balance residual between the optical pickups can be suppressed to a small value, and the optical pickups, of which the light receiving balance residual exceeds the allowable range, can be suppressed in number, to make unnecessary an adjustment after the movement adjustment of the photo-detector thereby to suppress the rise in the cost,

### Third Embodiment

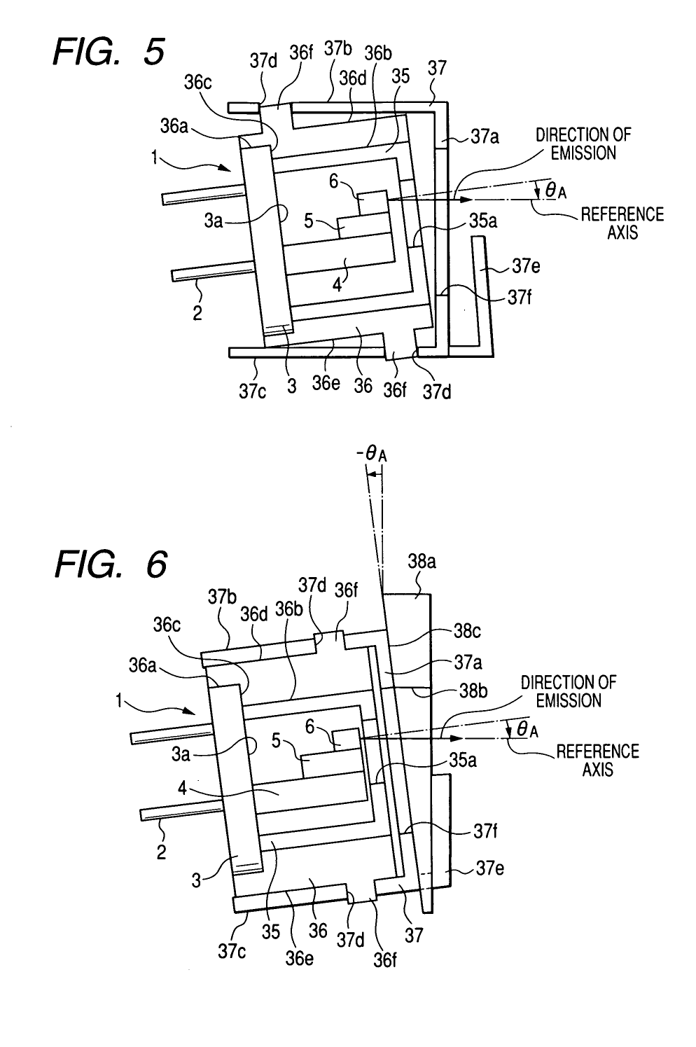

FIG. 5 is a sectional side elevation of a laser diode 1, an LD holder 36 and an LD spring 37 according to a third embodiment. By the aforementioned structure, the laser diode 1, the LD holder 36 and the LD spring 37 are integrated with the base portion 38 by the retaining portions 37e of the LD spring 37.

In the laser diode 1, the base 4 is protruded substantially orthogonally to the principal face 3a of the stem 3 The sub-mount 5 is mounted on the upper leading end of the base 4, and the monolithic LD 6 is mounted on the upper leading end of the sub-mount 5. The cap 35 is mounted on the principal face 3a of the stem 3 and provided in its front face with the hole 35a for passing the laser beam therethrough.

In the LD holder 36, the hole 36a and the hole 36b are so formed that the axis extending through the centers of the hole 36a and the hole 36b of the LD holder 36 may be substantially parallel to the upper face 36d and the lower face 36e of the LD holder 36. Moreover, the stem 3 is so press-fitted in the hole 36a as to bring the principal face 3a of the stem 3 into abutment against the abutment face 36c. Moreover, the protrusions 36f are formed at longitudinally displaced positions on the upper face 36d and the lower face 36e of the LD holder 36.

The holes 37d are individually formed at the longitudinally displaced positions in the leaf portion 37b and the leaf portion 37c of the LD spring 37. As shown in FIG. 5, moreover, the LD spring 37 is so arranged that the leaf portions 37b and 37c may be substantially parallel to the individual reference axes, and is integrated with the base portion 38 by the retaining portions 37e. As in the foregoing first embodiment, the average value of the angular deviation of the emission direction at the light emitting point 12 of the monolithic LD 6 orthogonal to the active layer is designated by θ_{A}. As shown in FIG. 5, moreover, the protrusions 36f are so fitted in the holes 37d that the monolithic LD 6 may be arranged such that the individual light emitting points of the monolithic LD 6 are positioned on the individual reference axes, and that the individual reference axes are deviated by θ_{A} orthogonally to the active layer from the directions orthogonal to the individual laminar faces containing the individual light emitting points, and the LD holder 36 having the laser diode 1 press-fitted therein is fixed on the LD spring 37 and integrated with the base portion 38.

As a result, the monolithic LD 6 is arranged to deviate the reference axes by θ_{A} orthogonally to the active layer from the direction orthogonal to the laminar faces containing the DVD light emitting points 12, so that the average emission direction of the DVD light emitting point 12 is aligned with the reference axis. In case, therefore, the laser beam emitted from the DVD light emitting point 12 is received by the light receiving portion 30 (for the DVD main beam) of the photo-detector 27, the center of gravity of the intensity of light is aligned on the average with the center of the light receiving portion 30 so that the light receiving balance becomes substantially 0 on the average. If the average value of the angular deviation of the emission direction of the CD light emitting point 13 is then equal to the same value θ_{A} as that of the DVD light emitting point 12, the average emission direction of the CD light emitting point 13 is also aligned with the reference axis, and the light receiving balance in the light receiving portion 33 (for the CD main beam) of the photo-detector 27 also becomes substantially 0 on the average, so that the average light receiving balance residual becomes substantially 0. Even in case the average value of the angular deviation of the emission direction of the CD light emitting point 13 is different from that of the DVD light emitting point 12, the average light receiving balance deviation is suppressed to a small value for the aforementioned reasons.

According to this third embodiment, the average light receiving balance residual between the optical pickups can be suppressed to a small value, and the optical pickups, of which the light receiving balance residual exceeds the allowable range, can be suppressed in number, to make unnecessary an adjustment after the movement adjustment of the photo-detector thereby to suppress the rise in the cost.

### Fourth Embodiment

FIG. 6 is a sectional side elevation of a laser diode 1, an LD holder 36, an LD spring 37 and a wall portion 38a of the base portion 38 according to a fourth embodiment.

In the laser diode 1, the base 4 is protruded substantially orthogonally to the principal face 3a of the stem 3. The sub-mount 5 is mounted on the upper leading end of the base 4, and the monolithic LD 6 is mounted on the upper leading end of the sub-mount 5. The cap 35 is mounted on the principal face 3a of the stem 3 and provided in its front face with the hole 35a for passing the laser beam therethrough.

In the LD holder 36, the hole 36a and the hole 36b are so formed that the axis extending through the centers of the hole 36a and the hole 36b of the LD holder 36 may be substantially parallel to the upper face 36d and the lower face 36e of the LD holder 36. Moreover, the stem 3 is so press-fitted in the hole 36a as to bring the principal face 3a of the stem 3 into abutment against the abutment face 36c. Moreover, the protrusions 36f are formed at longitudinally displaced positions on the upper face 36d and the lower face 36e of the LD holder 36.

The leaf portion 37b and the leaf portion 37c of the LD spring 37 are substantially orthogonal to the base portion 37a, and the holes 37d are individually formed in the leaf portion 37b and the leaf portion 37c at the longitudinally identical positions. Moreover, the protrusions 36f are so fitted in the holes 37d that the upper face 36d of the LD holder 36 and the leaf portion 37b, and the lower face 36e of the LD holder 36 and the leaf portion 37c may be substantially parallel to each other, and the LD holder 36 having the laser diode 1 press-fitted therein is fixed on the LD spring 37.

As in the foregoing first embodiment, the average value of the angular deviation of the emission direction at the light emitting point 12 of the monolithic LD 6 orthogonal to the active layer is designated by θ_{A}. At this time, as shown in FIG. 6, the stiffening face 38c belonging to the base portion 38 is formed such that it is inclined by −θ_{A} from the axis perpendicular the individual reference axes. Moreover, the LD spring 37 holding the LD holder 36 having the laser diode 1 press-fitted therein is fixed on the base portion 38 by bringing the base portion 37a of the LD spring 37 into abutment against the stiffening face 38c so that the individual light emitting points of the monolithic LD 6 may be positioned on the individual reference axes, and by hooking the retaining portions 37e on the two side lower portions of the wall portion 38a across the opening 38b.

As a result, the monolithic LD 6 is arranged to deviate the individual reference axes by θ_{A} orthogonally to the active layer from the direction orthogonal to the individual laminar faces containing the individual light emitting points, so that the average emission direction of the DVD light emitting point 12 is aligned with the reference axis. In case, therefore, the laser beam emitted from the DVD light emitting point 12 is received by the light receiving portion 30 (for the DVD main beam) of the photo-detector 27, the center of gravity of the intensity of light is aligned on the average with the center of the light receiving portion 30 so that the light receiving balance becomes substantially 0 on the average. If the average value of the angular deviation of the emission direction of the CD light emitting point 13 is then equal to the same value 6 A as that of the DVD light emitting point 12, the average emission direction of the CD light emitting point 13 is also aligned with the reference axis, and the light receiving balance in the light receiving portion 33 (for the CD main beam) of the photo-detector 27 also becomes substantially 0 on the average, so that the average light receiving balance residual becomes substantially 0. Even in case the average value of the angular deviation of the emission direction of the CD light emitting point 13 is different from that of the DVD light emitting point 12, the average light receiving balance deviation is suppressed to a small value for the aforementioned reasons.

According to this fourth embodiment, the average light receiving balance residual between the optical pickups can be suppressed to a small value, and the optical pickups, of which the light receiving balance residual exceeds the allowable range, can be suppressed in number, to make unnecessary an adjustment after the movement adjustment of the photo-detector thereby to suppress the rise in the cost.

What is claimed is:

1. An optical pickup comprising:
a laser diode including a stem, a base protruded from a principal face of the stem, a sub-mount arranged on the base, and a monolithic laser diode arranged on the sub-mount; and
a photo-detector including each light receiving portion formed on one substrate and corresponding to each laser beam emitted from the monolithic laser diode,
wherein a mounting face of the base for mounting the sub-mount is inclined by an angle with respect to an axis orthogonal to the principal face of the stem, and
the laser diode is arranged such that each light emitting point belonging to the monolithic laser diode is positioned on each reference axis, and such that each reference axis and the axis orthogonal to the principal face of the stem are substantially parallel to each other.

2. The optical pickup according to claim 1, wherein the angle corresponds to an average value of an angular deviation of emission direction orthogonal to an active layer at a light emitting point belonging to the monolithic laser diode.

3. An optical pickup comprising:
a laser diode including a stem, a base protruded from a principal face of the stem, a sub-mount arranged on the base, and a monolithic laser diode arranged on the sub-mount;
an LD holder having a hole for inserting the laser diode; and
a photo-detector including each light receiving portion formed on one substrate and corresponding to each laser beam emitted from the monolithic laser diode,
wherein the hole of the LD holder is formed such that an axis extending through a center of the hole is inclined from an axis parallel to an upper face and a lower face of the LD holder an angle, and
the LD holder having the laser diode inserted thereinto is arranged such that each light emitting point belonging to the monolithic laser diode is positioned on each reference axis, and such that each reference axis and the axis parallel to the upper face and the lower face of the LD holder are substantially parallel to each other.

4. The optical pickup according to claim 3, wherein the angle corresponds to an average value of an angular deviation of emission direction orthogonal to an active layer at the light emitting point belonging to the monolithic laser diode.

5. An optical pickup comprising:
a laser diode including a stem, a base protruded from a principal face of the stem, a sub-mount arranged on the base, and a monolithic laser diode arranged on the sub-mount;
an LD holder having a hole for inserting the laser diode and protrusions formed on an upper face and a lower face;
an LD spring having a base portion and leaf portions formed by folding two ends of the base portion; and
a photo-detector including each light receiving portion formed on one substrate and corresponding to each laser beam emitted from the monolithic laser diode,
wherein the hole of the LD holder is formed such that an axis extending through a center of the hole is substantially parallel to the upper face and the lower face of the LD holder,
the leaf portions have holes for fitting the protrusions therein, and the LD spring is arranged such that the leaf portions are substantially parallel to each reference axis, and
the LD holder having the laser diode inserted thereinto is fixed on the LD spring by fitting the protrusions in the holes belonging to the leaf portions, such that each light emitting point belonging to the monolithic laser diode is positioned on each reference axis, and such that each reference axis is inclined from a direction orthogonal to each laminar face containing the each light emitting point in a direction orthogonal to an active layer by an angle.

6. The optical pickup according to claim 5, wherein the angle corresponds to an average value of an angular deviation of emission direction orthogonal to the active layer at the light emitting point belonging to the monolithic laser diode.

7. An optical pickup comprising:
a laser diode including a stem, a base protruded from a principal face of the stem, a sub-mount arranged on the base, and a monolithic laser diode arranged on the sub-mount;
an LD holder having a hole for inserting the laser diode and protrusions formed on an upper face and a lower face;
an LD spring having a spring base portion and first and second leaf portions formed by folding end portions of the spring base portion substantially perpendicularly;
a base portion for retaining the LD spring; and
a photo-detector including each light receiving portion formed on one substrate and corresponding to each laser beam emitted from the monolithic laser diode,
wherein the hole of the LD holder is formed such that an axis extending through a center of the hole is substantially parallel to the upper face and the lower face of the LD holder,
the first and second leaf portions have holes for fitting the protrusions therein,
the LD holder having the laser diode inserted thereinto is fixed by the LD spring such that the first leaf portion and the upper face of the LD holder, and the second leaf portion and the lower face of the LD holder are substantially parallel to each other,
the base portion has a stiffening face, against which the base portion is brought into abutment, and the stiffening face is inclined from an axis orthogonal to each reference axis by an angle, and
the base portion is brought into abutment against the stiffening face such that each light emitting point belonging to the monolithic laser diode is positioned on each reference axis, and the LD spring, on which the LD holder having the laser diode inserted thereinto is fixed, is retained by the base portion.

8. The optical pickup according to claim 7, wherein the angle corresponds to an average value of an angular deviation of emission direction orthogonal to an active layer at the light emitting point belonging to the monolithic laser diode.

9. An optical pickup comprising;
a monolithic laser diode; and
a photo-detector including each light receiving portion formed on one substrate and corresponding to each laser beam emitted from the monolithic laser diode,
wherein the monolithic laser diode is arranged such that each light emitting point belonging to the monolithic laser diode is positioned on each reference axis, and such that each reference axis is inclined from a direction orthogonal to each laminar face containing the each light emitting point in a direction orthogonal to the active layer by an angle.

10. The optical pickup according to claim 9, wherein the angle corresponds to an average value of an angular deviation of emission direction orthogonal to the active layer at the light emitting point belonging to the monolithic laser diode.
